(19) United States
(12) Patent Application Publication
(10) Pub. No.: US 2015/0088943 A1
(43) Pub. Date: Mar. 26, 2015

(54) Media-Aware File System and Method

(71) Applicant: Futurewei Technologies, Inc., Plano, TX (US)

(72) Inventors: Xudong Song, Fremont, CA (US); Lulin Chen, Portland, OR (US); Xiaobing Lee, Santa Clara, CA (US)

(21) Appl. No.: 14/496,909

(22) Filed: Sep. 25, 2014

Related U.S. Application Data
(60) Provisional application No. 61/882,431, filed on Sep. 25, 2013.

(51) Int. Cl. G06F 17/30; H04L 12/24; H04L 29/08

(52) U.S. Cl. CPC G06F 17/302; H04L 67/1097; G06F 17/30584; G06F 17/30091; G06F 17/30946; H04L 41/22
USPC 707/827

(57) ABSTRACT

An embodiment Media-Aware File System (MAFS) includes a network node having a processor executing programming stored on a non-transitory computer readable medium of the network node. The programming includes instructions to: receive a first media stream made up of a plurality of primary frames; receive a primary namespace for the first media stream; determine a first file name for the first media stream and a second file name for a second media stream in accordance with the primary namespace; and determine a partition index for partitioning the first media stream into a plurality of groups of primary frames, including a first group having a first length in frames and a second group having a different length. The programming also includes instructions to determine the second media stream that includes a derived group of frames, including at least one frame that is derived in accordance with the first group.

This application claims the benefit of U.S. Provisional Application No. 61/882,431, filed on Sep. 25, 2013, which application is hereby incorporated herein by reference.

### TECHNICAL FIELD

The present invention relates generally to a system and method for file storage, and, in particular embodiments, to a media-aware file system and method.

### BACKGROUND

Traditional information technology (IT) storage is based on a distributed file system that stores media data into individual files. Storage from an IT perspective could be viewed as a bucket of bits in which one set of bits is treated equally to any other set. This model works well for the traditional IT professional, to whom one set of bits is essentially indistinguishable from any other. Yet traditional IT storage is not suitable for media storage in media workflows, which do not have the same goals as a traditional IT data center.

### SUMMARY

In accordance with an embodiment of the present invention, a method for media storage is provided. The method includes receiving a first media stream made up of a plurality of primary frames, receiving a primary namespace for the first media stream, and determining a partition index for partitioning the first media stream into a plurality of groups of primary frames. The plurality of groups of primary frames includes a first group having a first length in frames and a second group having a second length in frames that is different than the first length. The method also includes determining a second media stream that includes a derived group of frames. The derived group includes at least one frame that is derived in accordance with the first group. The method also includes determining a first file name for the first media stream and a second file name for the second media stream in accordance with the primary namespace.

In accordance with another embodiment of the invention, a Media-Aware File System (MAFS) is provided. The MAFS includes a network node that includes both a processor and a non-transitory computer readable medium storing programming for execution by the processor. The programming includes instructions to receive a first media stream made up of a plurality of primary frames, and to receive a primary namespace for the first media stream. The programming also includes instructions to determine a partition index for partitioning the first media stream into a plurality of groups of primary frames. The plurality of groups of primary frames includes a first group having a first length in frames and a second group having a second length in frames that is different than the first length. The programming also includes instructions to determine a second media stream that includes a derived group of frames. The derived group includes at least one frame that is derived in accordance with the first group. The programming also includes instructions to determine a first file name for the first media stream and a second file name for the second media stream in accordance with the primary namespace.

In accordance with another embodiment of the invention, a distributed storage system is provided. The system includes a plurality of network nodes. Each network node in the plurality includes a network interface, a node processor, and a node memory that includes a storage location of a non-transitory computer readable medium. Programming is stored in at least one first storage location in the plurality of network nodes, and this programming is for execution by at least one node processor in the plurality of network nodes. The programming includes instructions to receive a first media stream made up of a plurality of groups of primary frames, which in turn includes a first group assigned for storage in accordance with a first section of a first storage object, wherein the first group has a first length in frames. The programming also includes instructions to receive a second media stream that includes a derived group of frames that is derived in accordance with the first group, and to assign the derived group to a second section of the first storage object.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a distributed storage system in accordance with embodiments of the present invention;

FIG. 2 illustrates a functional block diagram of a media-aware distributed storage system incorporating a MAFS in accordance with embodiments of the present invention;

FIG. 3 is a flow chart illustrating a method for storing a media stream in accordance with embodiments of the present invention; and

FIG. 4 illustrates a block diagram of a processing system that may be used for implementing the devices and methods disclosed herein in accordance with embodiments of the present invention.

### DETAILED DESCRIPTION OF ILLUSTRATIVE EMBODIMENTS

The media professional is concerned with content and bandwidth of media files, and also with the quality, timeliness and meaning behind the bits of these files. Media files such as video files and critical audio files generally are much larger than other types of files. Thus, when dealing with media content the required bandwidth into and out of storage systems is very large. Additionally, a single media file on a storage system may need to be simultaneously accessed by multiple users. The time-based nature of media content also presents significant storage challenges.

An embodiment MAFS addresses these issues by carrying out media-aware policies to actively manage, assemble and disassemble frame-based audio and video clips for delivery to an application. By doing so, the MAFS can reduce storage cost and improve system performance of, for example, media production, media processing, media cataloging, media proxy workflow, and media format independence for use in broadcasting, media services, and multiple system operations. Media-aware policies supported by the MAFS include media clipping policies, media user experience parameters, media fragmentation features, and stream generation policies. Media user experience parameters include, for example, settings for initial delay, rebuffering time, requested playback data rate, rate variation, etc. Media fragmentation features specify how to distribute a large media stream in a distributed storage system that is supported by the MAFS. Stream generation policies set up which derived media streams are to be automatically generated and written to the distributed storage system when an original media stream is written to the distributed storage system.

These media-aware policies for automatically generating derived streams allow media processing components to be implemented at the storage layer. Instead of using multiple user namespaces for each sub-stream, an embodiment MAFS can use one namespace to manipulate the various sub-streams (i.e., the original media stream or derived media streams) in sequences of media frames with different sizes, different bit-rates, different resolutions, and with or without trick-modes, special-effects, indexing, and feature marks. Derived media streams that are generated during storage of an original stream can include, for example, sub-streams for fast-forward, reverse, or fast-reverse playing. Derived media streams can also include normal-speed reverse streams or various other sub-streams of differing playback speed, quality or resolution. In some embodiments, these derived media streams can be made up of derived frames that are simply a subset of the frames of the original media stream, such as, for example, I-frame only “trick-mode” streams. In other embodiments, the derived media streams can also include streams that are made up of frames that are altered from the original frames or added to the original frames in accordance with a pre-set algorithm. For example, a stream can include new frames that are created by interpolating between original frames. Stream generation policies can also specify that in anticipation of future editing of the original media stream, a derived media stream that is a low-resolution ghost copy will be automatically generated when the original media stream is stored in the distributed storage system. In an embodiment, such tasks are done in local nodes where media streams are stored, with minimum amount of data movement throughout the distributed storage system.

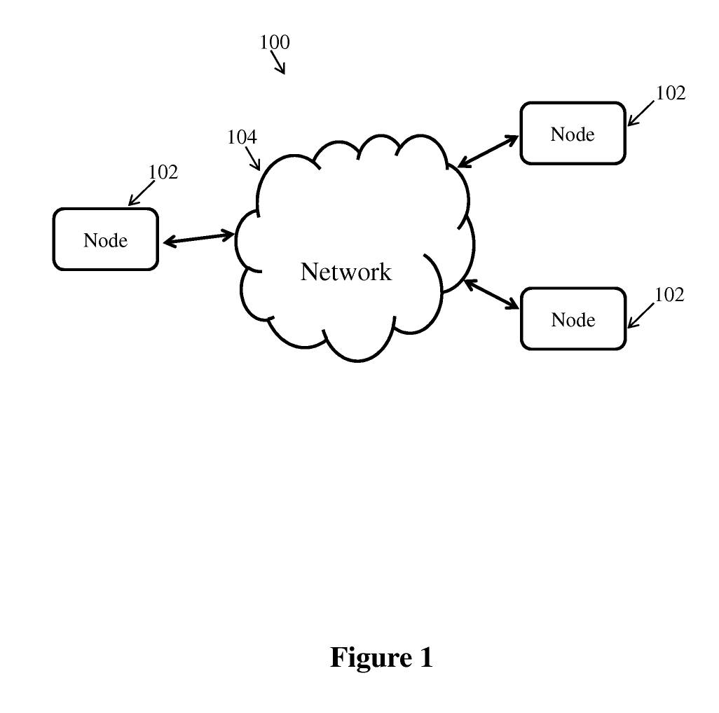

FIG. 1 illustrates an embodiment distributed storage system 10 that is supported by the MAFS. As shown, the embodiment distributed storage system 100 includes several nodes 102 communicating through a network 104 which may be, for example, a Fibre Channel network, HyperSCSI network, Infiniband network, local area network, Internet cloud networks, etc. It should be recognized that a practical application of the embodiment distributed storage system 100 may include components, devices, hardware, and so on, which have not been included in FIG. 1 for ease of illustration. The distributed storage system distributes processing and data storage to the multiple nodes 102 to improve scalability and availability. The nodes 102 in the storage cluster are loosely connected or tightly connected computers that work together so that in many respects they can be viewed as a single system. The multiple nodes 102 help to avoid a single point of failure and are scalable to provide increasing numbers of users with improved user experience.

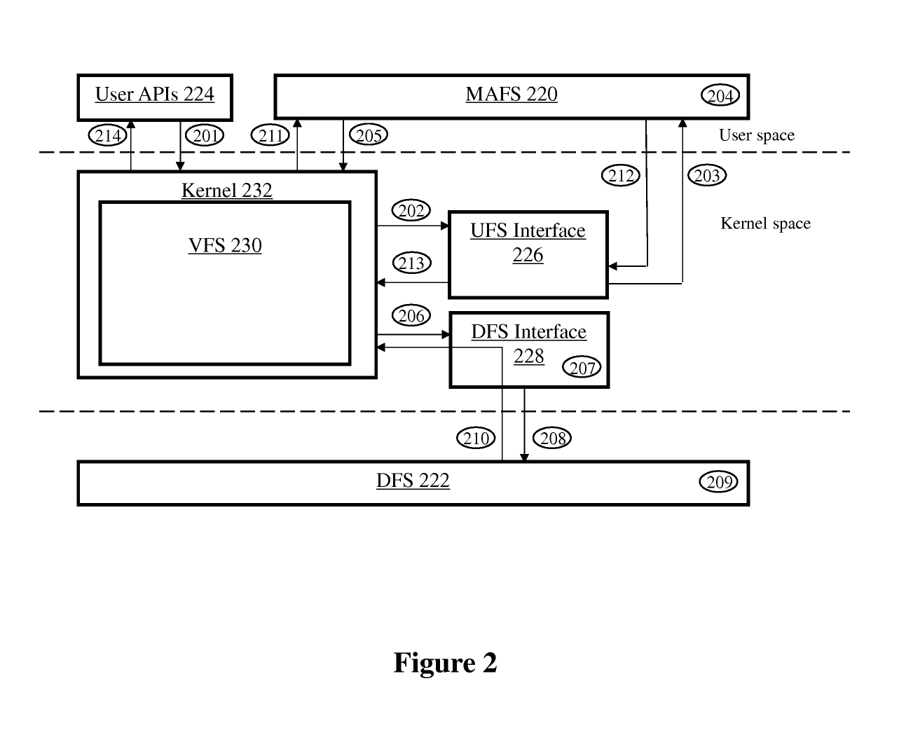

FIG. 2 illustrates one embodiment functional block diagram of a media-aware distributed storage system incorporating a MAFS 220. The functions of the embodiment storage system may be conceptually organized into user space functions, kernel space functions, and a Distributed File System (DFS) 222 for reading or writing data to the nodes of the distributed storage system. The user space includes a MAFS 220 and one or more user Application Program Interfaces (APIs) 224. The kernel space includes a Userland File System (UFS) Interface 226, a DFS Interface 228, and an operating system kernel 230 with a Virtual File System (VFS) 232 that communicates with the UFS Interface 226.

The storage system of FIG. 2 is configured to perform the following steps that are indicated in the figure:

201. A user directs that an original multiple frame media stream be written to a file name space in the MAFS 220 (mounted as a volume of the kernel 230), and the user APIs 224 translate this media command into kernel operations.

202. The kernel 230 sends this media stream to a virtual drive of the UFS Interface 226.

203. The UFS Interface 226 uses the virtual drive to pass the media stream to the MAFS 220.

204. The MAFS 220 begins to determine a partition index for partitioning the media stream into multiple varying length chunks, i.e., groups of frames. The MAFS 220 begins to derive one or more streams from the original stream in accordance with media-aware policies. The MAFS 220 determines the partition index and derived streams in group-by-group fashion.

205. MAFS 220 passes back to the kernel 230, group by group, the groups of derived frames corresponding to a group of original frames, as well as the partition index for the group of original frames.

206. The kernel 230 writes the derived and original media streams in groups of frames, group-by-group, to the DFS Interface 228.

207. For each group of original frames, the DFS Interface 228 repacks the original frames with corresponding groups of frames of the derived streams for virtual storage in sections of a single storage object to be physically distributed across the nodes.

208. For each group of original frames, the repacked original frames and the corresponding groups of frames of the derived streams are written to the DFS 222 in accordance with the partition index.

209. For each group of frames, the DFS 222 pseudo-randomly distributes multiple copies over the nodes for high reliability and availability.

210. For each group of frames, a callback message is sent back to the kernel 230 to confirm this write to the DFS 222 is “done.”

211. The kernel 230 releases MAFS 220 to process the next group of frames at step 4, group by group, until the entire media stream is scanned and distributed into the nodes with additional derived media streams. In other embodiments, each of steps 4 through 10 is performed for all groups of frames in the media stream before the next step begins.

212. MAFS 220 sets up the virtual drive of the UFS Interface 226 to associate the stored frames with an original file name and derived file names in accordance with the single namespace.

213. The UFS Interface 226 makes the file changes to the virtual drive and calls back to the kernel 230.

214. The kernel 230 informs the user that this media segment was confirmed in the DFS 222 by, for example, displaying the primary namespace at a user terminal.

Describing now the functional blocks of FIG. 2 in greater detail, the DFS 222 reads and writes media segments to virtual locations of the DFS 222 referred to here as “storage objects” that are each associated with a set of data that is distributed over the nodes. The storage objects may be implemented as fixed-sized blocks of data or using flexible-sized data storage containers such as, for example, Object Storage Device (OSD) blocks. The DFS 222 distributes the data associated with these storage objects to storage locations in the nodes of the distributed storage system. In an embodiment, the DFS 222 selects storage locations for storing these storage objects using a pseudo-random data distribution algorithm, such as a hash function or CRUSH algorithm. In another embodiment, the DFS 222 distributes multiple copies of the data in each storage object across the nodes to ensure high reliability and availability.

The UFS Interface 226, which interfaces with the MAFS 220 to support media aware features, policies, indexing, and generation of derived media streams, can be, for example, a Filesystem in Userspace (FUSE) interface, Linux UFS (LUFS) interface, etc. The UFS Interface 226 allows appending the software of the MAFS 220 onto an existing kernel in a manner that requires only small modifications to the existing kernel and is transparent to user applications. In other embodiments, the MAFS 220 may be partially or completely integrated into the software of the kernel 230, which may obviate the need for UFS Interface 226 or VFS 232.

In an embodiment, the kernel 230 exchanges media stream files with the MAFS 220 through the UFS Interface 226 by writing the file or a subset of its media segments to a virtual drive associated with volatile memory locations that are distributed in the nodes. This virtual drive may be implemented using various well-known volatile memory technologies, including for example, a RAMdisk made up of blocks of random access memory (RAM). In embodiments of the present invention, the virtual drive may be implemented using static RAM (SRAM), dynamic RAM (DRAM), synchronous DRAM (SDRAM), or the like. The virtual drive can play back all sets of buffered media streams for debugging.

The kernel space includes an operating system kernel 230 that manages input/output requests from software, and translates them into data processing instructions for central processing unit (CPU) and other computer components of one or more of the nodes. The functions of the kernel 230 may be performed by the same node that is accessed by the user, at a separate media processing node, or in a distributed manner among various nodes.

In one embodiment, the kernel 230 may be based on, for example, the kernel of a POSIX-compatible operating system, such as Linux or Unix. In other embodiments, the kernel 230 may be based on the kernel of Microsoft Windows or another operating system that is not POSIX-compatible. The kernel 230 uses a VFS 232 that translates file systems that are external to the kernel 230 (such as the MAFS 220 or another UFS, the DFS 222, or for example, an EXT3 system in the kernel space) so that the kernel 230 can read and write files to the external file system. In an embodiment, the kernel 230 runs on a computer that uses zero-copy file mapping, which enhances performance by allowing a CPU processing operations of the kernel 230 to perform other tasks while files are copied in parallel in another computer component that is external to the CPU.

The user APIs 224 provide a software interface between a user and the kernel 230, which in turn uses the MAFS 220 as a software interface to the DFS 222. User APIs 224 allow the user to execute media commands to read, write, and edit media files by translating these commands into actions by the kernel 230. In some embodiments, this kernel translation process generates a workflow action list. User APIs 224 also allow the user to set up media-aware policies. In addition to being set up by the user APIs 224, media-aware policies can also be set up by, for example, a storage system operator, by the MAFS 220, or by default implementation in the user API's kernel translation process.

The embodiment MAFS 220, which can be mounted as a volume of the kernel 230, can use the virtual drive of the UFS Interface 226 as scratch memory during MAFS processing. The MAFS 220 prepares a partition index to partition the media stream into small file chunks that are groups of individual frames. The MAFS 220 also generates derived media streams in accordance with the media-aware policies. The MAFS 220 can also analyze commonly used commands or the structure of commonly used streams to set up media-aware policies that are tailored to the type of media processing that is most likely to occur (e.g., streaming playback, editing, video production, special effects, animation, etc.). The MAFS 220 can also set up media-aware policies that are tailored to the relative availability of transcoding hardware that is able to do real-time decoding and transcoding.

To prepare a partition index, the MAFS 220 determines where partition boundaries in the original media stream should be placed in accordance with ordinary media features, for example, Group of Pictures (GOP) structures, long gaps in the action of a film, etc. In GOP partitioning, the beginning of each new chunk is an I-frame that begins a new GOP. In long-gap partitioning, the beginning of each new chunk can be determined by examining the number of changing elements between neighboring frames and then finding boundaries where this change reaches a local minimum. Long gap partitioning is often suitable for partitioning media streams such as slow-moving dramas that have more local minima, while GOP partitioning is a more general technique that can also be applied to media with fast-paced action.

The MAFS 220 generates the partition index in accordance with the partition boundaries to divide the media streams in file chunks of varying length (in frames). Each partitioned file chunk is independent from another file chunk. The MAFS 220 can also provide detailed information about the associated storage object sections and file names of each file chunk in the nodes themselves. Therefore, each node's CPU may be configured to access local disk data to read and write the file chunk, which will result in significantly improved overall system performance in media processing.

The MAFS 220 generates frames of derived streams by, for example, transcoding some or all I-frames of the media stream as a “trick-mode” fast-forward stream or fast-backward stream, or a low resolution proxy editing stream. In an embodiment, the MAFS processing is distributed across multiple nodes of the distributed storage system, each of which process the media segments stored in its local disks so that the MAFS 220 can perform transcoding many times faster than real-time media playback. In other embodiments, the transcoding is performed by hardware on which the MAFS 220 does not reside. In some embodiments, this transcoding hardware may include dedicated transcoding processors.

The MAFS 220 associates the stored chunks of the original media stream and the derived media stream with a single namespace accessible by the user through the user API. The MAFS 220 nevertheless sets up the virtual drive to associate individual file names with the distributed chunks of each of the original and derived media streams. These file names are hidden from the user but are used by the MAFS 220 for executing media commands generated by a user or application. For example, the MAFS 220 might set up the virtual drive to make 4 sub-files: file_name.orig, file_name.ff, file_name.bf, and file_name.sif, which respectively are associated with distributed chunks of the original media stream, a derived fast-forward stream, a derived reverse stream, and a derived low-resolution editable stream. When a user requests playing “file_name” in fast-forward, this command would cause MAFS 220 to fetch “file_name.ff” to play in fast-forward. The fast-forward file would then be presented by displaying or playing the file frame-by-frame by a user application in a suitable format in accordance with the media type. If the user requests cutting or parsing “file_name,” the MAFS 220 will fetch “file_name.sif” to present a ghost copy for editing. After the user is satisfied with the editing results, a final real cut-parse version is generated by MAFS 220 at the original resolution and is distributed by the DFS 222 for storage in the nodes. In an embodiment, multiple users can team up from different access locations at nodes of the distributed storage system to edit the “file_name” media stream. Even though these multiple users are manipulating what they view as the same media file having only one namespace, they can work on different sub-streams of the media file with low networking impact. The MAFS 220 will execute each editing change at the proper nodes that stored each unedited media stream to generate each final release version.

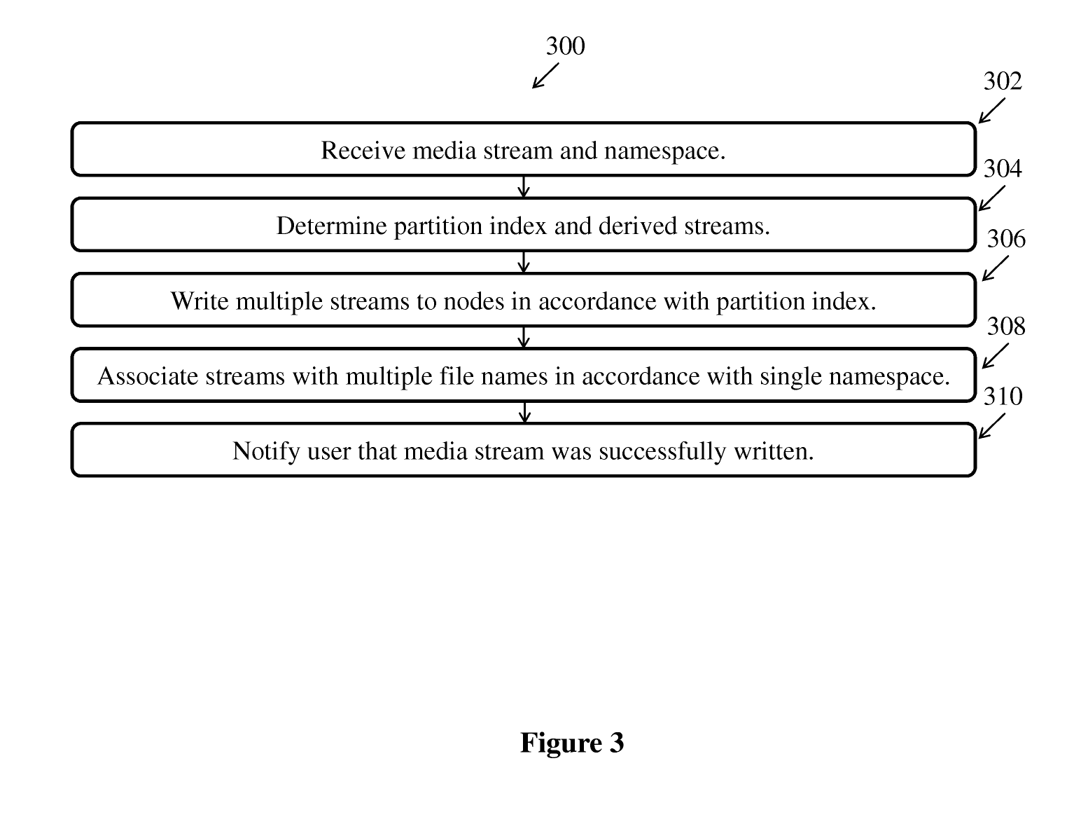

Referring to FIG. 3, an embodiment method 300 for storing a media stream is illustrated. At 302, the storage system receives a media stream to be written to the nodes. This can occur when a user writes an original multiple frame media stream and its file name space to the MAFS volume, and the user APIs then translate this write command into kernel operations. The kernel 230 then sends this media stream to the virtual drive of the UFS Interface 226, which passes the media stream to the MAFS 220.

At 304, the MAFS 220 determines the partition index and derived streams. The MAFS 220 determines the partition index for partitioning the media stream into multiple varying length groups of frames. The MAFS 220 also derives one or more streams from the original stream in accordance with media-aware policies. Each derived media stream includes groups of derived frames that each correspond to a respective group of original frames of the original media stream. MAFS 220 then passes the original media stream, the derived media streams, as well as the partition index for the group of original frames.

At 306, the original and derived streams are written to the nodes. In accordance with the partition index, the kernel 230 writes the derived and original media streams in groups of frames to the DFS Interface 228. For each group of original frames, the DFS Interface 228 repacks the original frames with the corresponding groups of frames of the derived streams for virtual storage together at a single storage object to be physically distributed across the storage locations of the nodes. For each file chunk, the original frames of the chunk are all assigned by the DFS Interface 228 to be written into a first section of a storage object. The DFS Interface 228 is designed to pack each chunk of derived media streams with the corresponding chunk of the original media stream so that it will be stored in storage locations associated with other sections of the same storage object. Each of these storage objects associated with a chunk of original frames and its corresponding derived frames is then written to the DFS 222. In an embodiment, the DFS 222 distributes multiple copies of the data associated with each storage object over the nodes using a pseudo-random algorithm such as a hash or CRUSH algorithm.

At 308, file names are determined in accordance with the user namespace and are associated with the groups of original and derived frames. The MAFS 220 determines an original file name and derived file names in accordance with the single namespace, and sets up the virtual drive of the UFS Interface 226 to respectively associate the original file name and the derived file names with the stored groups of original frames and groups of derived frames. The UFS Interface 226 creates the file associations in the virtual drive and calls back to the kernel 230.

At 310, the user is notified that the media stream was successfully written. The kernel 230 informs the user that this media segment was confirmed in the DFS 222 by, for example, displaying the primary namespace at a user terminal.

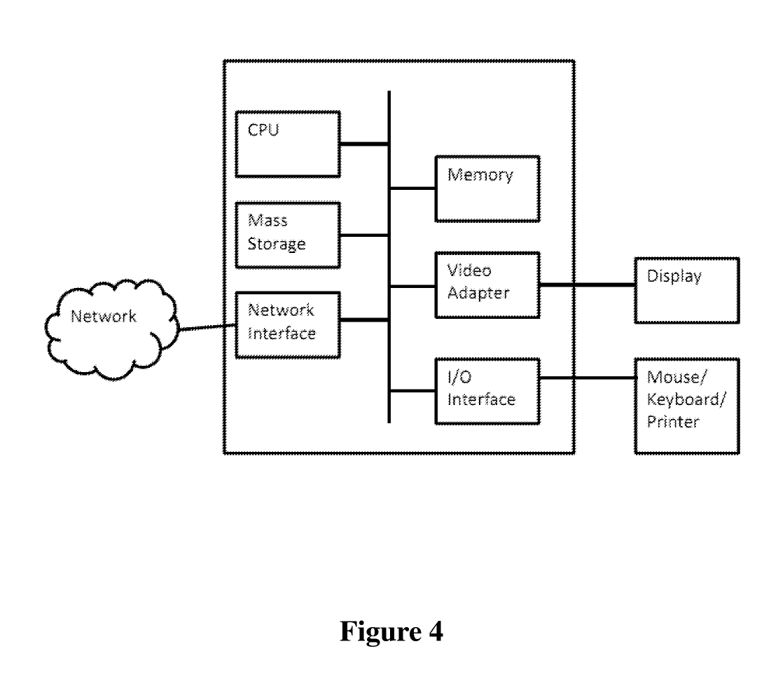

Referring now to FIG. 4, a block diagram of a processing system is illustrated that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. In an embodiment, the processing system comprises a computer workstation. The processing system may comprise a processing unit equipped with one or more input/output devices, such as a speaker, microphone, mouse, touchscreen, keypad, keyboard, printer, display, and the like. The processing unit may include a CPU, memory, a mass storage device, a video adapter, and an I/O interface connected to a bus. In an embodiment, multiple processing units in a single processing system or in multiple processing systems may form a distributed processing pool or distributed editing pool.

The bus may be one or more of any type of several bus architectures including a memory bus or memory controller, a peripheral bus, video bus, or the like. The CPU may comprise any type of electronic data processor. The memory may comprise any type of system memory such as SRAM, DRAM, SDRAM, read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for media storage comprising:
receiving a first media stream comprising a plurality of primary frames;
receiving a primary namespace for the first media stream;
determining a partition index for partitioning the first media stream into a plurality of groups of primary frames;
wherein the plurality of groups of primary frames comprises:
a first group having a first length in frames;
a second group having a second length in frames that is different than the first length;
determining a second media stream comprising a derived group, the derived group comprising at least one frame that is derived in accordance with the first group;
determining a first file name for the first media stream in accordance with the primary namespace; and
determining a second file name for the second media stream in accordance with the primary namespace.

2. The method of claim 1, wherein the determining the partition index is in accordance with at least one group boundary comprising at least one of an I-frame and a local minimum in change between adjacent frames.

3. The method of claim 1,
wherein the derived group comprises at least one of a subset of the first group and an interpolated frame comprising an interpolation between two primary frames of the first group.

4. The method of claim 1 further comprising:
associating the first file name with a first section of a first storage object in a plurality of storage objects; and
associating the second file name with a second section of the first storage object.

5. The method of claim 4 further comprising:
associating the first section of the first storage object with at least one first storage location in a plurality of network nodes;
associating the second section of the first storage object with at least one second storage location in the plurality of network nodes;
storing the first group in the at least one first storage location; and
storing the derived group in the at least one second storage location.

6. The method of claim 5 further comprising:
selecting the at least one first storage location and the at least one second storage location from a plurality of storage locations in the plurality of network nodes in accordance with a pseudo-random distribution algorithm.

7. The method of claim 5 further comprising:
associating the first section with at least one third storage location in the plurality of network nodes;
associating the second section with at least one fourth location in the plurality of network nodes;
storing the first group in the at least one third storage location; and
storing the derived group in the at least one fourth storage location.

8. The method of claim 1 further comprising:
receiving a media access request comprising:
the primary namespace; and
a media command;
determining a selected file name in accordance with the primary namespace and the media command, the selected file name comprising at least one of the first file name and the second file name;
determining, in accordance with the selected file name, a selected storage object and a selected section of the selected storage object;
determining, in accordance with the selected section, at least one selected storage location;
retrieving, from the at least one selected storage location, a selected media stream comprising at least one of the first media stream and the second media stream; and
presenting the selected media stream at a user terminal.

9. A media aware file system comprising a network node, wherein the network node comprises:
a processor;
a non-transitory computer readable medium storing programming for execution by the processor, the programming comprising instructions to:
receive a first media stream comprising a plurality of primary frames;
receive a primary namespace for the first media stream;
determine a partition index for partitioning the first media stream into a plurality of groups of primary frames;
wherein the plurality of groups of primary frames comprises:
a first group having a first length in frames;
a second group having a second length in frames that is different than the first length;
determine a second media stream comprising a derived group, the derived group comprising at least one frame that is derived in accordance with the first group;
determine a first file name for the first media stream in accordance with the primary namespace; and
determine a second file name for the second media stream in accordance with the primary namespace.

10. The system of claim 9,
wherein the instructions to determine the partition index comprise instructions to determine the partition index in accordance with at least one group boundary, and
wherein the at least one group boundary comprises at least one of an I-frame and a local minimum in change between adjacent frames.

11. The system of claim 9,
wherein the derived group comprises at least one of a subset of the first group and an interpolated frame comprising an interpolation between two primary frames of the first group.

12. The system of claim 9,
wherein the first file name is associated with a first section of a first storage object in a plurality of storage objects; and
wherein the second file name is associated with a second section of the first storage object.

13. The system of claim 12,
wherein the first section of the first storage object is associated with at least one first storage location in a plurality of storage locations; and
wherein the second section of the first storage object is associated with at least one second storage location in the plurality of storage locations.

14. The system of claim 13,
wherein the first group is stored in the at least one first storage location; and
wherein the derived group is stored in the at least one second storage location.

15. The system of claim 9, wherein the programming further comprises instructions to:
receive a media access request comprising:
the primary namespace; and
a media command;
determine a selected file name in accordance with the primary namespace and the media command, the selected file name comprising at least one of the first file name and the second file name; and
retrieve a selected media stream in accordance with the selected file name, the selected media stream comprising at least one of the first media stream and the second media stream.

16. A distributed file system comprising:
a plurality of network nodes, wherein each network node in the plurality of network nodes comprises:
a network interface;
a node processor;
a node memory comprising a storage location of a non-transitory computer readable medium;
wherein programming is stored in at least one first storage location in the plurality of network nodes;
wherein the programming is for execution by at least one node processor in the plurality of network nodes; and
wherein the programming comprises instructions to:
receive a first media stream comprising a plurality of groups of primary frames,
wherein the plurality of groups of primary frames comprises a first group assigned for storage in accordance with a first section of a first storage object, and
wherein the first group has a first length in frames;
receive a second media stream comprising a derived group of frames that is derived in accordance with the first group; and
assign the derived group to a second section of the first storage object.

17. The system of claim 16, wherein the plurality of groups of primary frames further comprises at least one second group having a second length in frames that is different than the first length.

18. The system of claim 16,
wherein an initial frame of the first group comprises at least one of an I-frame and a local minimum in change between adjacent frames of the first media stream.

19. The system of claim 16,
wherein the derived group comprises at least one of a subset of the first group and an interpolated frame comprising an interpolation between two primary frames of the first group.

20. The system of claim 16, wherein the programming further comprises instructions to:
associate the first section of the first storage object with at least one second storage location in the plurality of network nodes; and
associate the second section of the first storage object with at least one third storage location in the plurality of network nodes.

21. The system of claim 20, wherein the programming further comprises instructions to:
select the at least one second storage location and the at least one third storage location from the plurality of network nodes in accordance with a pseudo-random distribution algorithm.

22. The system of claim 20, wherein the programming further comprises instructions to:
store the first group in the at least one second storage location in the plurality of network nodes; and
store the derived group in the at least one third storage location in the plurality of network nodes.

23. The system of claim 22, wherein the programming further comprises instructions to:
associate the first section with at least one fourth storage location in the plurality of network nodes;
associate the second section with at least one fifth storage location in the plurality of network nodes;
store the first group in the at least one fourth storage location; and
store the derived group in the at least one fifth storage location.

24. The system of claim 16, wherein the programming further comprises instructions to:
receive a selected file name, wherein the file name is associated with a stored media stream comprising at least one of the first media stream and the second media stream;
determine, in accordance with the selected file name, a selected storage object and a selected section of the selected storage object;
determine, in accordance with the selected section, at least one selected storage location; and
retrieve, from the at least one selected storage location, a selected media stream comprising at least one of the first media stream and the second media stream.
